(19) United States
(12) Patent Application Publication
(10) Pub. No.: US 2026/0082151 A1
(43) Pub. Date: Mar. 19, 2026

(54) ACOUSTIC DEVICE AND SIGNAL PROCESSING METHOD

(71) Applicant: Shenzhen Shokz Co., Ltd., Shenzhen (CN)

(72) Inventors: Guangyuan ZHU, Shenzhen (CN); Gong YUE, Shenzhen (CN); Lei ZHANG, Shenzhen (CN); Xin QI, Shenzhen (CN)

(73) Assignee: Shenzhen Shokz Co., Ltd., Shenzhen (CN)

(21) Appl. No.: 19/399,744

(22) Filed: Nov. 25, 2025

Related U.S. Application Data
(63) Continuation of application No. PCT/CN2023/131090, filed on Nov. 10, 2023.

(30) Foreign Application Priority Data
Oct. 30, 2023 (CN) 202311437363.7

(51) Int. Cl. H04R 3/04

(52) U.S. Cl. CPC H04R 3/04; H04R 2430/03; H04R 2460/13

(57) ABSTRACT

To provide an acoustic output device which utilizes a combination of an air-transmitted sound with a bone-transmitted sound produced through bone transmission, and therefore can reproduce a more natural and realistic stereophonic sound regardless of the shapes of ears, the differences among individuals or the faultiness in a recording system or a regeneration system. [Solution] An acoustic output device is provided, which is equipped with an air-transmitted sound display unit for displaying an air-transmitted sound and a bone-transmitted sound display unit for displaying a bone-transmitted sound, wherein the bone-transmitted sound display unit is located at a position which is not in the vicinity of an ear of a user when the user puts on the acoustic output device. According to the acoustic output device, a stereophonic sound can be regenerated regardless of the shapes of ears, the differences among individuals or the faultiness in a recording system or a regeneration system.

### RELATED APPLICATIONS

This application is a continuation application of PCT application No. PCT/CN2023/131090, filed on Nov. 10, 2023, which claims the benefit of priority of Chinese patent application filed with China National Intellectual Property Administration on Oct. 30, 2023, with application No. 2023114373637 and application title “Acoustic Device and Signal Processing Method”, the entire contents of the foregoing documents are incorporated herein by reference.

### TECHNICAL FIELD

The present disclosure relates to the field of acoustic technology, and particularly relates to an acoustic device and a signal processing method.

### BACKGROUND

Portable acoustic device (such as headphones) has been widely applied in people's daily lives, which can be used in conjunction with electronic devices such as mobile phones and computers to provide users with an auditory feast.

According to the working principle of acoustic device, acoustic device can be divided into air conduction acoustic device and bone conduction acoustic device. Among them, air conduction acoustic device is based on air conduction of sound waves, while bone conduction acoustic device is based on bone conduction of sound waves.

The content in the background technology section is merely information known to the inventor personally, and does not represent that the above information has entered the public domain before the filing date of the present disclosure, nor does it represent that it can become prior art of the present disclosure.

### SUMMARY

The present disclosure provides an acoustic device and a signal processing method, which, for an audio signal to be played, uses a bone conduction sound component to play a first component in an audio signal, and uses an air conduction sound component to play a second component in the audio signal component, and can avoid the problem of sound deviation.

In a first aspect, an acoustic device is provided, including: a bone conduction sound component, configured to generate a first time delay when converting a first driving signal into a bone conduction sound wave; an air conduction sound component, configured to generate a second time delay when converting a second driving signal into an air conduction sound wave, where an absolute value of a difference between the second time delay and the first time delay is greater than 100 microseconds; and a signal processing circuit, in communication with the bone conduction sound component and the air conduction sound component, when operating: obtain an audio signal, generates the first driving signal based on a first component of the audio signal and sends to the bone conduction sound component to drive the bone conduction sound component to convert the first driving signal into the bone conduction sound wave, and generates the second driving signal based on a second component of the audio signal and sends to the air conduction sound component to drive the air conduction sound component to convert the second driving signal into the air conduction sound wave, where one of the first driving signal and the second driving signal is delayed relative to the other, so that at least at partial frequencies the bone conduction sound wave is generated at a first time, the air conduction sound wave is generated at a second time, and a time difference between the first time and the second time is less than or equal to 100 microseconds.

In a second aspect, a signal processing method is provided, the method is applied to an acoustic device comprising a bone conduction sound component, an air conduction sound component and a signal processing circuit, the bone conduction sound component is configured to generate a first time delay when converting a first driving signal into a bone conduction sound wave, the air conduction sound component is configured to generate a second time delay when converting a second driving signal into an air conduction sound wave, and an absolute value of a difference between the second time delay and the first time delay is greater than 100 microseconds, the method includes: by the processing circuit, obtain an audio signal; generates the first driving signal based on a first component of the audio signal and sends to the bone conduction sound component to drive the bone conduction sound component to convert the first driving signal into the bone conduction sound wave; and generates the second driving signal based on a second component of the audio signal and sends to the air conduction sound component to drive the air conduction sound component to convert the second driving signal into the air conduction sound wave, where one of the first driving signal and the second driving signal is delayed relative to the other, so that at least at partial frequencies the bone conduction sound wave is generated at a first time, the air conduction sound wave is generated at a second time, and a time difference between the first time and the second time is less than or equal to 100 microseconds.

From the above technical solutions, it can be seen that the acoustic device and signal processing method provided by the present disclosure, for an audio signal to be played, uses a bone conduction sound component to play a first component in the audio signal (for example, mid-high frequency component), and uses an air conduction sound component to play a second component in the audio signal (for example, mid-low frequency component), realizing the mutual integration of two sound transmission methods of bone conduction and air conduction. The mid-low frequency air conduction sound waves can be used as a supplement to the mid-high frequency bone conduction sound waves, which can avoid the problem that the bone conduction sound component has poor performance in the low frequency part and brings strong vibration sensation to users. In addition, the total output of the acoustic device can cover mid-low frequencies and mid-high frequencies, thereby providing better sound listening experience. Furthermore, the acoustic device delays the transmission of one of the first driving signal and the second driving signal relative to the other, so that the time difference between the generation moment of bone conduction sound waves and the generation moment of air conduction sound waves at at least some frequencies is small (less than or equal to 100 microseconds), so that the target user will not feel the asynchronization between bone conduction sound waves and air conduction sound waves, thereby avoiding the problem of sound deviation.

Other functions of the acoustic device and signal processing method provided by the present disclosure will be partially listed in the following description. The creative aspects of the acoustic device and signal processing method provided by the present disclosure can be fully explained through practice or use of the methods, apparatus and combinations described in the detailed examples below.

### BRIEF DESCRIPTION OF THE DRAWINGS

In order to more clearly illustrate the technical solutions in the embodiments of the present disclosure, the drawings required for use in the description of the embodiments will be briefly introduced below. Obviously, the drawings described below are only some exemplary embodiments of the present disclosure. For a person of ordinary skill in the art, other drawings can also be obtained based on these drawings without creative effort.

FIG. 1 shows a system architecture example diagram of an acoustic device provided according to some exemplary embodiments of the present disclosure;

FIG. 2 shows a working delay schematic diagram of a bone conduction sound component and an air conduction sound component under one situation;

FIG. 3 shows a working delay schematic diagram of a bone conduction sound component and an air conduction sound component under another situation;

FIG. 4 shows a system architecture schematic diagram of another acoustic device provided according to some exemplary embodiments of the present disclosure;

FIG. 5 shows a frequency response curve schematic diagram of bone conduction sound waves and air conduction sound waves output by the acoustic device;

FIG. 6A shows a schematic diagram of a single audio test signal with 30 cycles;

FIG. 6B shows the recording result of a bone conduction sound component generating bone conduction test sound waves with 30 cycles;

FIG. 6C shows the recording result of an air conduction sound component generating air conduction test sound waves with 30 cycles;

FIG. 7 shows a schematic diagram of delayed transmission of the first driving signal;

FIG. 8 shows a schematic diagram of delayed transmission of the second driving signal;

FIG. 9 shows a system architecture schematic diagram of yet another acoustic device provided according to some exemplary embodiments of the present disclosure; and

FIG. 10 shows a flow schematic diagram of a signal processing method provided according to some exemplary embodiments of the present disclosure.

### DETAILED DESCRIPTION

The following description provides specific application scenarios and requirements of the present disclosure, with the purpose of enabling a person skilled in the art to manufacture and use the contents of the present disclosure. For a person skilled in the art, various local modifications to the disclosed embodiments are obvious, and the general principles defined herein can be applied to other embodiments and applications without departing from the spirit and scope of the present disclosure. Therefore, the present disclosure is not limited to the shown embodiments, but is consistent with the broadest scope of the claims.

The terminology used herein is for the purpose of describing particular example embodiments only and is not intended to be limiting. For example, unless the context clearly indicates otherwise, as used herein, the singular forms “a,” “an,” and “the” may also include plural forms. When used in the present disclosure, the terms “include,” “comprise,” and/or “contain” mean that the associated integers, steps, operations, elements and/or components are present, but do not exclude the presence of one or more other features, integers, steps, operations, elements, components and/or groups, or that other features, integers, steps, operations, elements, components and/or groups can be added to the system/method.

In consideration of the following description, these features and other features of the present disclosure, as well as the operation and function of related elements of the structure, and the economy of combination and manufacture of components can be significantly improved. Reference is made to the accompanying drawings, all of which form part of the present disclosure. However, it should be clearly understood that the drawings are for purposes of illustration and description only and are not intended to limit the scope of the present disclosure. It should also be understood that the drawings are not drawn to scale.

The flowcharts used in the present disclosure illustrate operations implemented by systems according to some exemplary embodiments in the present disclosure. It should be clearly understood that the operations of the flowcharts may be implemented out of order. Conversely, the operations may be implemented in reverse order or simultaneously. Furthermore, one or more other operations may be added to the flowcharts. One or more operations may be removed from the flowcharts.

In the embodiments of the present disclosure, the use of prefix words such as “first,” “second,” etc. is merely for the convenience of distinguishing and describing different things belonging to the same name category, and does not constrain the order or quantity of things. For example, “first information” and “second information” are merely information of different content or purpose, and there is no temporal relationship or priority relationship between them. The first information may be one piece of information or multiple pieces of information, and the second information may also be one piece of information or multiple pieces of information.

In the embodiments of the present disclosure, “at least one” refers to one or more, and “multiple” refers to two or more. “And/or” describes the association relationship of associated objects, indicating that three relationships may exist. For example, A and/or B can represent the following three situations: A exists alone; A and B exist simultaneously; B exists alone; where A and B can be singular or plural. The character “/” generally indicates that the objects associated before and after are in an “or” relationship. “At least one of the following” or similar expressions refer to any combination of these items, including any combination of single item(s) or multiple items. For example, at least one of a, b, or c can represent: a; b; c; a and b; a and c; b and c; or a and b and c, where a, b, c can be single or multiple.

The acoustic device provided by the present disclosure is a wearable acoustic device. The acoustic device can be worn on the head of a target user and output sound to the target user. For example, the acoustic device can be worn at positions near the two ears of the target user, and in this case the acoustic device can also be called headphones. It should be noted that the acoustic device provided by the present disclosure can be designed in various forms, such as: over-ear form, glasses form, ear-hook form, ear-hook+behind-the-head form, ear-clip form, etc. The present disclosure does not limit the specific form of the acoustic device.

The acoustic device provided by the present disclosure can be headphones that combine bone conduction and air conduction. That is to say, the acoustic device can transmit sound to the human ear both through bone conduction (for example, through skull conduction of the head) and through air conduction. The acoustic device provided by the present disclosure will be described in detail below in conjunction with the accompanying drawings.

FIG. 1 shows a system architecture example diagram of an acoustic device 100 provided according to some exemplary embodiments of the present disclosure. As shown in FIG. 1, the acoustic device 100 may include a bone conduction sound component 110, an air conduction sound component 120, a signal processing circuit 130, and an audio input component 140.

The bone conduction sound component 110 and air conduction sound component 120 are both communicatively connected to the signal processing circuit 130. The bone conduction sound component 110 can receive electrical signals carrying audio information from the signal processing circuit 130 and convert them into bone conduction sound waves. Bone conduction sound waves refer to sound waves conducted to the inner ear via bone conduction through mechanical vibration, and can also be called bone conduction sound. The air conduction sound component 120 can receive electrical signals carrying audio information from the signal processing circuit 130 and convert them into air conduction sound waves. Air conduction sound waves refer to sound waves conducted to the inner ear via air conduction through mechanical vibration, and can also be called air conduction sound.

For the convenience of distinction, the present disclosure refers to the electrical signal received by the bone conduction sound component 110 from the signal processing circuit 130 as the first driving signal, and refers to the electrical signal received by the air conduction sound component 120 from the signal processing circuit 130 as the second driving signal.

Continuing to refer to FIG. 1, the bone conduction sound component 110 may include a bone conduction speaker 112. The bone conduction speaker 112 is a device for converting electrical signals into bone conduction sound waves, and can also be called an electroacoustic transducer or bone conduction speaker.

In addition to including the bone conduction speaker 112, the bone conduction sound component 110 may also include a first peripheral circuit (for example, a first power amplifier 111). The first peripheral circuit may be located at the input end of the bone conduction speaker 112. For example, in FIG. 1, the first peripheral circuit may be connected between the signal processing circuit 130 and the bone conduction speaker 112. The first peripheral circuit may receive the first driving signal from the signal processing circuit 130 and perform some processing on the first driving signal, so that the processed electrical signal is suitable for the bone conduction speaker 112 to play and has a better listening effect. In some exemplary embodiments, the first peripheral circuit may include one or more circuit elements, such as power amplifier elements, digital-to-analog/analog-to-digital conversion elements, filtering elements, capacitors, inductors, etc. A person skilled in the art can understand that for convenience of illustration, FIG. 1 only shows the power amplifier element in the first peripheral circuit and marks it as the first power amplifier 111.

Continuing to refer to FIG. 1, the air conduction sound component 120 may include an air conduction speaker 122. The air conduction speaker 122 is a device for converting electrical signals into air conduction sound waves, and can also be called an electroacoustic transducer or air conduction speaker.

In addition to including the air conduction speaker 122, the air conduction sound component 120 may also include a second peripheral circuit (for example, a second power amplifier 121). The second peripheral circuit may be located at the input end of the air conduction speaker 122. For example, in FIG. 1, the second peripheral circuit may be connected between the signal processing circuit 130 and the air conduction speaker 122. The second peripheral circuit may receive the second driving signal from the signal processing circuit 130 and perform some processing on the second driving signal, so that the processed electrical signal is suitable for the air conduction speaker 122 to play and has a better listening effect. In some exemplary embodiments, the second peripheral circuit may include one or more circuit elements, such as power amplifier elements, digital-to-analog/analog-to-digital conversion elements, filtering elements, capacitors, inductors, etc. A person skilled in the art can understand that for convenience of illustration, FIG. 1 only shows the power amplifier element in the second peripheral circuit and marks it as the second power amplifier 121.

The signal processing circuit 130 is a circuit with certain signal processing capabilities. Referring to FIG. 1, the signal processing circuit 130 may be communicatively connected to the audio input component 140. The signal processing circuit 130 may obtain an audio signal to be played from the audio input component 140. In some exemplary embodiments, the audio input component 140 may be a component with storage function, and the audio signal may be a signal pre-stored in the audio input component 140. In this case, the signal processing circuit 130 may obtain the audio signal from the audio input component 140. In some exemplary embodiments, the audio input component 140 may correspond to an audio interface of the acoustic device 100. The acoustic device 100 may be communicatively connected to a control device (such as mobile phones, tablets, computers, etc.) through the audio interface and receive the audio signal from the control device. In some exemplary embodiments, the audio input component 140 may correspond to a sound pickup component of the acoustic device 100. The acoustic device 100 picks up environmental sound through the sound pickup component and converts it into the audio signal, and the signal processing circuit 130 may obtain the audio signal from the sound pickup component.

The signal processing circuit 130 is communicatively connected to the bone conduction sound component 110 and the air conduction sound component 120. After the signal processing circuit 130 obtains the audio signal to be played, it may perform frequency division operation on the audio signal to obtain the first driving signal and the second driving signal. Furthermore, the signal processing circuit 130 may send the first driving signal to the bone conduction sound component 110 and send the second driving signal to the air conduction sound component 120.

When the signal processing circuit 130 executes a frequency division operation, it may generate the first driving signal based on the first component in the audio signal, and generate the second driving signal based on the second component in the audio signal. The first component and the second component may respectively correspond to different frequency components in the audio signal. For example, in some exemplary embodiments, the first component may correspond to the mid-high frequency component in the audio signal, and the second component may correspond to the mid-low frequency component in the audio signal.

In the present disclosure, different frequency ranges can be determined according to actual needs. For example, low frequency can refer to the frequency band of approximately 20 Hz to 150 Hz, mid frequency can refer to the frequency band of approximately 150 Hz to 5K Hz, high frequency can refer to the frequency band of approximately 5K Hz to 20K Hz, mid-low frequency can refer to the frequency band of approximately 150 Hz to 500 Hz, and mid-high frequency refers to the frequency band of 500 Hz to 5K Hz. In another example, low frequency can refer to the frequency band of approximately 20-300 Hz, mid frequency range can refer to the frequency band of approximately 300 Hz-3 k Hz, high frequency range can refer to 3 k Hz-20 k Hz frequency band, mid-low frequency can refer to 100 Hz-1 k Hz frequency band, and mid-high frequency can refer to 1 k Hz-10 k Hz frequency band. A person of ordinary skill in the art will understand that the above frequency band divisions are only given as an example to roughly provide intervals. The definitions of the above frequency bands can change with different industries, different application scenarios and different classification standards. For example, in some other application scenarios, low frequency refers to the frequency band of approximately 20 Hz to 80 Hz, mid-low frequency can refer to the frequency band of approximately 80 Hz-160 Hz, mid frequency can refer to the frequency band of approximately 160 Hz to 1280 Hz, mid-high frequency can refer to the frequency band of approximately 1280 Hz-2560 Hz, and high frequency band can refer to the frequency band of approximately 2560 Hz to 20K Hz. It should be noted that in some scenarios, there can also be overlapping frequencies between different frequency ranges.

In some exemplary embodiments, the signal processing circuit 130 may generate the first driving signal in the following manner. The signal processing circuit 130 filters the audio signal through a first filter to obtain the first component. The first filter is configured to allow mid-high frequency components in the audio signal to pass through, therefore, the first filter can also be called a high-pass filter. It should be noted that the present disclosure does not limit the type of the first filter. For example, in some exemplary embodiments, the first filter may use a 4th-order digital filter. After the signal processing circuit 130 obtains the first component, it may generate the first driving signal based on the first component. For example, the first driving signal may be obtained by performing a target operation on the first component. In some exemplary embodiments, the target operation may include but is not limited to one or more of filtering operations and gain operations. A person skilled in the art can understand that the first driving signal generated in the above manner corresponds to the mid-high frequency signal components in the audio signal.

In some exemplary embodiments, the signal processing circuit 130 may generate the second driving signal in the following manner. The signal processing circuit 130 filters the audio signal through a second filter to obtain the second component. The second filter is configured to allow mid-low frequency components in the audio signal to pass through, therefore, the second filter can also be called a low-pass filter. It should be noted that the present disclosure does not limit the type of the second filter. For example, in some exemplary embodiments, the second filter may use a 4th-order digital filter. After the signal processing circuit 130 obtains the second component, it may generate the second driving signal based on the second component. For example, the second driving signal may be obtained by performing a target operation on the second component. In some exemplary embodiments, the target operation may include but is not limited to one or more of filtering operations and gain operations. A person skilled in the art can understand that the second driving signal generated in the above manner corresponds to the mid-low frequency signal components in the audio signal.

The acoustic device 100 provided by the present disclosure converts the mid-high frequency components in the audio signal into bone conduction sound waves through the bone conduction sound component 110, and converts the mid-low frequency components in the audio signal into air conduction sound waves through the air conduction sound component 120, realizing the mutual integration of two sound transmission methods of bone conduction and air conduction. The mid-low frequency air conduction sound waves can be used as a supplement to the mid-high frequency bone conduction sound waves, which can avoid the problem that the bone conduction sound component 110 has poor performance in the low frequency part and brings strong vibration sensation to users. The total output of the acoustic device 100 can cover mid-low frequency and mid-high frequency, thereby providing better sound listening experience.

Based on the system architecture of the acoustic device 100 shown in FIG. 1, both the bone conduction sound component 110 and the air conduction sound component 120 have certain delays during operation. For convenience of description, the present disclosure refers to “the delay generated when the bone conduction sound component 110 converts the first driving signal into bone conduction sound waves” as the first delay, and refers to “the delay generated when the air conduction sound component 120 converts the second driving signal into air conduction sound waves” as the second delay. The first delay can refer to: the time interval from when the bone conduction sound component 110 receives the first driving signal to when it outputs bone conduction sound waves. The second delay can refer to: the time interval from when the air conduction sound component 120 receives the second driving signal to when it outputs air conduction sound waves.

A person skilled in the art can understand that the above-mentioned first delay is related to the hardware solution adopted by the bone conduction sound component 110 (i.e., the components used in the bone conduction sound component 110). When the bone conduction sound component 110 adopts different hardware solutions, the first delay generated during the operation of the bone conduction sound component 110 will be different. Similarly, the above-mentioned second delay is related to the hardware solution adopted by the air conduction sound component 120 (i.e., the components used in the air conduction sound component 120). When the air conduction sound component 120 adopts different hardware solutions, the second delay generated during the operation of the air conduction sound component 120 will also be different.

In practical applications, for different application scenarios, the bone conduction sound component 110 and air conduction sound component 120 usually adopt different hardware solutions to adapt to the needs of different scenarios. In some exemplary embodiments, when the acoustic device 100 is applied to scenarios with high power consumption requirements, in order to make the overall power consumption of the acoustic device 100 lower, the following hardware solution is usually adopted: the first power amplifier 111 in the bone conduction sound component 110 adopts an analog power amplifier, while the second power amplifier 121 in the air conduction sound component 120 adopts a digital power amplifier.

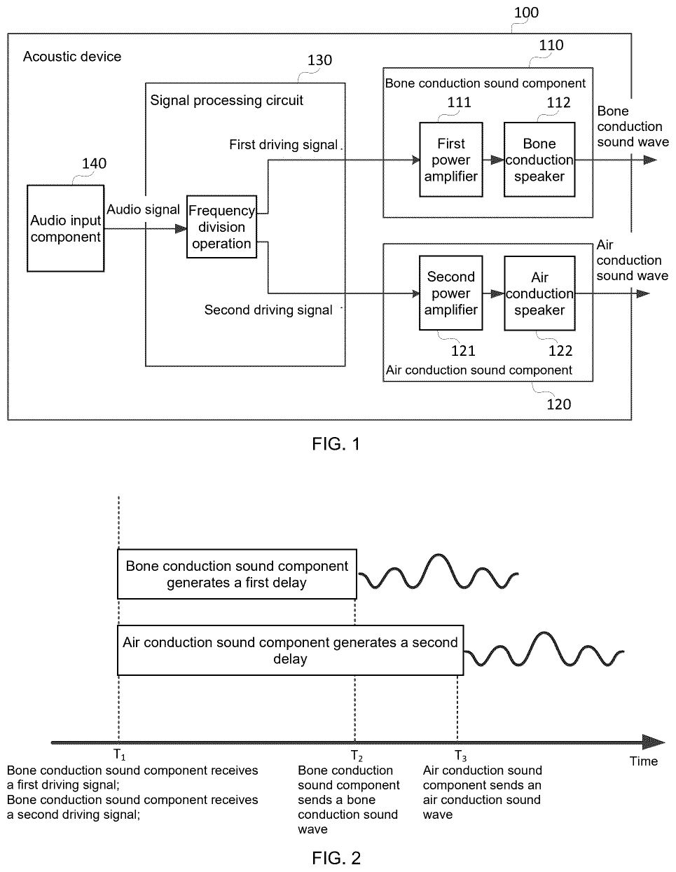

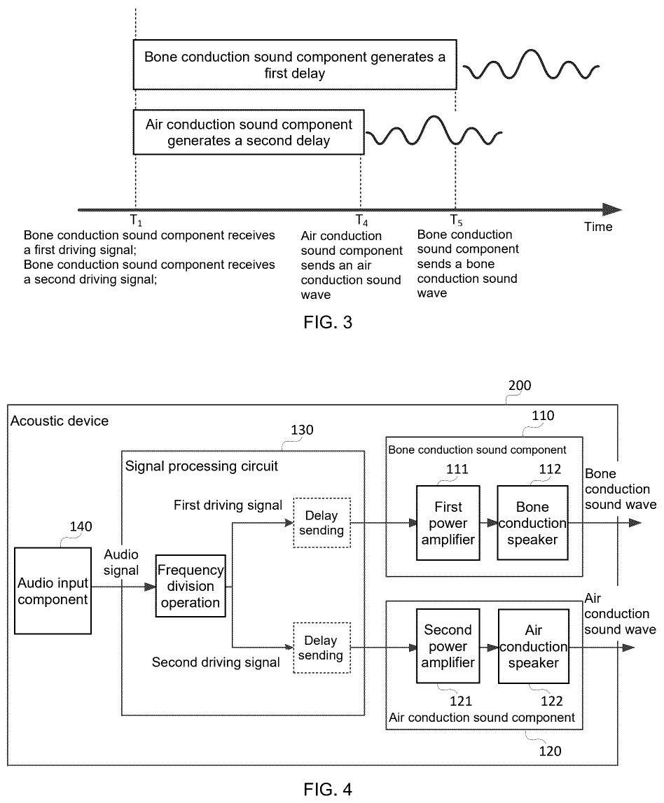

When the first power amplifier 111 is an analog power amplifier and the second power amplifier 121 is a digital power amplifier, due to the different operating speeds of the analog power amplifier and the digital power amplifier, the first delay generated by the bone conduction sound component 110 is different from the second delay generated by the air conduction sound component 120. Furthermore, when the first delay and the second delay are different, if the bone conduction sound component 110 and the air conduction sound component 120 receive the driving signal simultaneously, it will result in the bone conduction sound wave and the air conduction sound wave not being emitted synchronously. The following is an example explanation with reference to FIG. 2 and FIG. 3.

FIG. 2 illustrates a schematic diagram of the operational delays of the bone conduction sound component 110 and the air conduction sound component 120 in one scenario. As shown in FIG. 2, it is assumed that the first delay generated by the bone conduction sound component 110 during operation is less than the second delay generated by the air conduction sound component 120 during operation. In this case, if the bone conduction sound component 110 and the air conduction sound component 120 receive the driving signal simultaneously, i.e., the bone conduction sound component 110 receives the first driving signal at time T₁, and the air conduction sound component 120 receives the second driving signal at time T₁. Since the first delay generated by the bone conduction sound component 110 during operation is less than the second delay generated by the air conduction sound component 120 during operation, the bone conduction sound component 110 will emit sound waves before the air conduction sound component 120. That is, the bone conduction sound component 110 emits the bone conduction sound wave at time T₂, while the air conduction sound component 120 emits the air conduction sound wave at time T₃, with time T₂ being earlier than time T₃.

FIG. 3 illustrates a schematic diagram of the operational delays of the bone conduction sound component 110 and the air conduction sound component 120 in another scenario. As shown in FIG. 3, it is assumed that the first delay generated by the bone conduction sound component 110 during operation is greater than the second delay generated by the air conduction sound component 120 during operation. In this case, if the bone conduction sound component 110 and the air conduction sound component 120 receive the driving signal simultaneously, i.e., the bone conduction sound component 110 receives the first driving signal at time T₁, and the air conduction sound component 120 receives the second driving signal at time T₁. Since the first delay generated by the bone conduction sound component 110 during operation is greater than the second delay generated by the air conduction sound component 120 during operation, the air conduction sound component 120 will emit sound waves before the bone conduction sound component 110. That is, the air conduction sound component 120 emits the air conduction sound wave at time T₄, while the bone conduction sound component 110 emits the bone conduction sound wave at time T₅, with time T₄ being earlier than time T₅.

As can be seen from FIG. 2 and FIG. 3, when the first delay generated by the bone conduction sound component 110 during operation is different from the second delay generated by the air conduction sound component 120 during operation (e.g., the first delay is less than the second delay, or the first delay is greater than the second delay), the acoustic device 100 cannot synchronously emit the bone conduction sound wave and the air conduction sound wave. Assuming that the acoustic device 100 generates the bone conduction sound wave at a first moment and generates the air conduction sound wave at a second moment, there exists a time difference between the first moment and the second moment. Furthermore, when the aforementioned time difference is significant (e.g., greater than 100 microseconds), the target user can noticeably perceive the asynchrony between the bone conduction sound wave and the air conduction sound wave, thereby leading to a sound deviation problem. In the present disclosure, sound deviation refers to a user's auditory perception where the sound position is perceived as being biased to the left or to the right. The sound deviation problem reduces the user's experience with the acoustic device 100.

To this end, the present disclosure also provides an acoustic device 200, which, after generating the first driving signal and the second driving signal based on the audio signal, delays the transmission of at least one of the first driving signal and the second driving signal, so that at at least some frequencies, the time difference between the generation moment of the bone conduction sound wave and the generation moment of the air conduction sound wave is small (for example, less than or equal to 100 microseconds), thereby avoiding the sound deviation problem. The acoustic device 200 provided in the present disclosure is described in detail below in conjunction with FIG. 4.

FIG. 4 illustrates a schematic diagram of the system architecture of another acoustic device 200 provided according to some exemplary embodiments of the present disclosure. Comparing FIG. 4 with FIG. 1, it can be seen that the system architecture of acoustic device 200 is similar to that of acoustic device 100, with the difference being that: after the signal processing circuit 130 generates the first driving signal and the second driving signal by performing a frequency division operation, it can perform a “delayed transmission operation” on at least one of the first driving signal and the second driving signal, such that one is delayed relative to the other. For example, the first driving signal is delayed relative to the second driving signal, or the second driving signal is delayed relative to the first driving signal.

It should be noted that the “delayed transmission operation” in FIG. 4 is marked with a dashed box, indicating that the signal processing circuit 130 can selectively perform the “delayed transmission operation.” For example, the signal processing circuit 130 may perform the “delayed transmission operation” on the first driving signal while not performing it on the second driving signal, such that the first driving signal is delayed relative to the second driving signal. Alternatively, the signal processing circuit 130 may perform the “delayed transmission operation” on the second driving signal while not performing it on the first driving signal, such that the second driving signal is delayed relative to the first driving signal. As another example, the signal processing circuit 130 may perform the “delayed transmission operation” on both the first driving signal and the second driving signal, but with different delay durations, such that one is delayed relative to the other.

The signal processing circuit 130 performs a “delayed transmission operation” on at least one of the first driving signal and the second driving signal to achieve a delay of one relative to the other, such that at at least some frequencies, the time difference between the generation moment of the bone conduction sound wave and the generation moment of the air conduction sound wave is small, for example, the time difference may be less than or equal to 100 microseconds. As a result, the target user will not perceive asynchrony between the bone conduction sound wave and the air conduction sound wave, thereby avoiding the sound deviation problem.

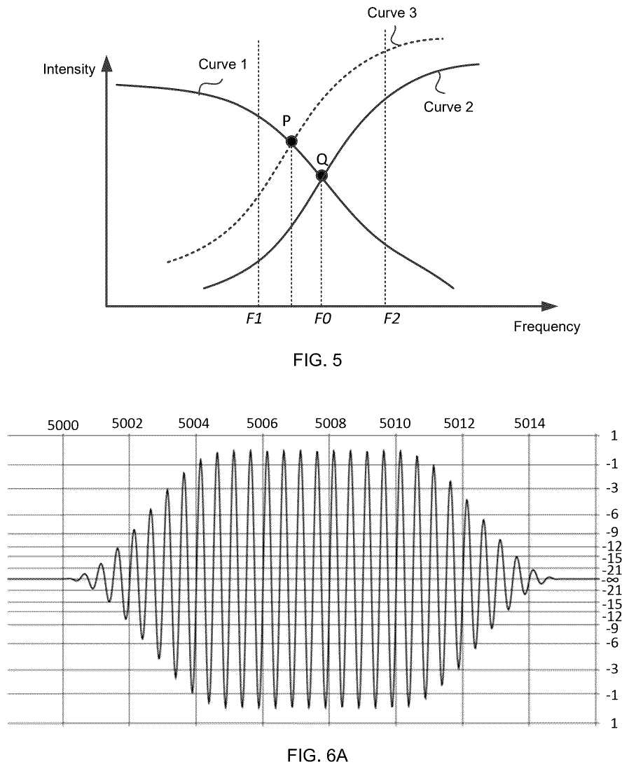

The sound received by the target user is a composite of the bone conduction sound wave and the air conduction sound wave. FIG. 5 illustrates a schematic diagram of the frequency response curves of the bone conduction sound wave and the air conduction sound wave output by the acoustic device. As shown in FIG. 5, Curve 1 represents the frequency response curve of the air conduction sound wave, and Curve 2 represents the frequency response curve of the bone conduction sound wave. Based on Curve 1 and Curve 2, it can be understood that: in the low-frequency band (e.g., frequency range less than F1), the intensity of the air conduction sound wave received by the target user is significantly greater than that of the bone conduction sound wave, meaning that the target user's auditory perception is primarily determined by the air conduction sound wave. Therefore, in the low-frequency band, even if there is a time difference between the generation moment of the bone conduction sound wave and the generation moment of the air conduction sound wave, the target user typically does not perceive noticeable sound deviation. In the high-frequency band (e.g., frequency range greater than F2), the intensity of the bone conduction sound wave received by the target user is significantly greater than that of the air conduction sound wave, meaning that the target user's auditory perception is primarily determined by the bone conduction sound wave. Therefore, in the high-frequency band, even if there is a time difference between the generation moment of the bone conduction sound wave and the generation moment of the air conduction sound wave, the target user typically does not perceive noticeable sound deviation. However, in the mid-frequency band (e.g., frequency range between F1 and F2), the intensity of the bone conduction sound wave and the air conduction sound wave are comparable, so when there is a time difference between the generation moment of the bone conduction sound wave and the generation moment of the air conduction sound wave, especially when the time difference is greater than 100 microseconds, the target user will perceive noticeable sound deviation.

From the above analysis, it can be understood that when the acoustic device satisfies the following Condition A, it can effectively avoid the sound deviation problem. Condition A: At frequencies corresponding to the mid-frequency band, the time difference between the generation moment of the bone conduction sound wave and the generation moment of the air conduction sound wave is small (less than or equal to 100 microseconds). Therefore, in some exemplary embodiments, the aforementioned at least some frequencies may include the frequencies of the mid-frequency band. That is to say, the signal processing circuit 130 can perform a “delayed transmission operation” on at least one of the first driving signal and the second driving signal, such that at the frequencies of the mid-frequency band, the time difference between the generation moment of the bone conduction sound wave and the generation moment of the air conduction sound wave is small (less than or equal to 100 microseconds).

In some exemplary embodiments, the aforementioned at least some frequencies may include frequencies within the frequency range [freq, 2*freq], where freq is the frequency corresponding to the intersection point of the voltage curves of the first driving signal and the second driving signal. For example, assuming the frequency corresponding to the intersection point of the voltage curves of the first driving signal and the second driving signal is 1200 Hz, the signal processing circuit performs a “delayed transmission operation” on at least one of the first driving signal and the second driving signal, such that at least at some frequencies within the frequency range [1200 Hz, 2400 Hz], the time difference between the generation moment of the bone conduction sound wave and the generation moment of the air conduction sound wave is small (less than or equal to 100 microseconds). Here, the voltage curves of the first driving signal and the second driving signal can both be obtained by detecting the output signals of the circuit board (the circuit board corresponding to the signal processing circuit 130).

Continuing to refer to FIG. 5, the intersection point of Curve 1 and Curve 2 is denoted as Q, and the frequency corresponding to the intersection point Q is referred to as the target frequency F0. Since the target frequency F0 corresponds to the intersection point of the bone conduction sound wave and the air conduction sound wave, before the target frequency F0, the intensity of the air conduction sound wave is greater than that of the bone conduction sound wave, while after the target frequency F0, the intensity of the bone conduction sound wave is greater than that of the air conduction sound wave. Therefore, the aforementioned target frequency F0 can also be referred to as the crossover frequency between the bone conduction sound wave and the air conduction sound wave (i.e., the frequency corresponding to the intersection point).

It should be noted that the aforementioned target frequency F0 refers to the frequency corresponding to the acoustic intersection point between the bone conduction sound wave and the air conduction sound wave, that is, the intersection point perceived by the target user's auditory experience. In practical applications, due to the relatively low energy conversion efficiency of the bone conduction speaker 112, the current intensity of the driving signal for the bone conduction speaker 112 is typically increased to enhance the output volume of the bone conduction speaker 112. This causes the frequency response curve of the bone conduction sound wave obtained from actual testing to shift upward, with the shifted frequency response curve shown as Curve 3 in FIG. 5 (represented by a dashed line). As seen in FIG. 5, the intersection point of the frequency response curve of the bone conduction sound wave obtained from actual testing and the frequency response curve of the air conduction sound wave shifts leftward to point P. When the target frequency is 2000 Hz, the frequency corresponding to the intersection point P obtained from actual measurement is approximately 1200 Hz. In some exemplary embodiments, considering that testing the frequency response curve of the bone conduction sound wave is relatively inconvenient, the electrical signal corresponding to the bone conduction sound wave (i.e., Curve 3 in FIG. 5) can be used instead of the frequency response curve of the bone conduction sound wave. In this case, the intersection point of the frequency response curves of the bone conduction sound wave and the air conduction sound wave is point P.

Since the target frequency F0 corresponds to the intersection point Q of the frequency curves of the bone conduction sound wave and the air conduction sound wave, the intensity of the bone conduction sound wave and the air conduction sound wave at the target frequency F0 is equal, meaning that the bone conduction sound wave and the air conduction sound wave have a comparable impact on the user's auditory perception. Therefore, the delay situation between the bone conduction sound wave and the air conduction sound wave at the target frequency 10 has a significant impact on the sound deviation problem. In other words, the sound deviation problem of the acoustic device is largely caused by the asynchrony between the bone conduction sound wave and the air conduction sound wave at the target frequency F0.

From the above analysis, it can be understood that when the acoustic device satisfies the following Condition B, it can more effectively avoid the sound deviation problem. Condition B: At the target frequency F0, the time difference between the generation moment of the bone conduction sound wave and the generation moment of the air conduction sound wave is small (less than or equal to 100 microseconds). Therefore, in some exemplary embodiments, the aforementioned at least some frequencies may include the target frequency F0. That is to say, the signal processing circuit 130 can perform a “delayed transmission operation” on at least one of the first driving signal and the second driving signal, such that at the target frequency F0, the time difference between the generation moment of the bone conduction sound wave and the generation moment of the air conduction sound wave is small (less than or equal to 100 microseconds).

In some exemplary embodiments, the target frequency F0 may be 500 Hz. In this case, the air conduction sound wave primarily covers the frequency range below 500 Hz, while the bone conduction sound wave primarily covers the frequency range above 500 Hz. Since in the frequency range above 500 Hz, the bone conduction sound wave hardly produces a sensation of vibration in the human body, when the target frequency is 500 Hz, the user barely perceives the vibration sensation of the acoustic device, which can enhance the user's wearing experience.

In some exemplary embodiments, the target frequency F0 may be 2000 Hz. In this case, the air conduction sound wave primarily covers the frequency range below 2000 Hz, while the bone conduction sound wave primarily covers the frequency range above 2000 Hz. The sensitivity of the bone conduction sound component 110 is lower compared to the air conduction sound component 120, resulting in higher power consumption for the bone conduction sound component 110 and lower power consumption for the air conduction sound component 120. By increasing the target frequency F0 from 500 Hz to 2000 Hz, under the premise of avoiding vibration sensation for the user, the frequency range covered by the air conduction sound wave is expanded, and the frequency range covered by the bone conduction sound wave is reduced. This effectively leverages the advantage of the lower power consumption of the air conduction sound component 120, thereby reducing the overall power consumption of the acoustic device.

The following describes in detail how the signal processing circuit 130 determines which driving signal to perform the delayed transmission operation on, and how to perform the delayed transmission operation. The test data involved in the description below is illustrated by taking the first power amplifier 111 as an analog power amplifier and the second power amplifier 121 as a digital power amplifier as an example.

The inventors found in actual research that the first delay generated by the bone conduction sound component 110 during operation is not fixed, but varies with frequency. For example, the first delay generated by the bone conduction sound component 110 at frequency f1 is D_{f1}^{A}, while at frequency f2, the first delay is D_{f2}^{A}, where D_{f2}^{A}≠D_{f1}^{A}. Similarly, the second delay generated by the air conduction sound component 120 during operation is not fixed either, but varies with frequency. For example, the second delay generated by the air conduction sound component 120 at frequency f1 is D_{f1}^{B}, while at frequency f2, the second delay is D_{f2}^{B}, where D_{f1}^{B}≠D_{f1}^{B}.

Furthermore, the inventor also found in actual research that the magnitude relationship between the first delay and the second delay is not fixed, but varies with frequency changes. For example, for frequency f1, the first delay generated by the bone conduction sound component 110 during operation is D_{f1}^{A}, and the second delay generated by the air conduction sound component 120 during operation is D_{f1}^{B}, where D_{f1}^{B}>D_{f1}^{A}. For frequency f2, the first delay generated by the bone conduction sound component 110 during operation is D_{f2}^{A}, and the second delay generated by the air conduction sound component 120 during operation is D_{f2}^{B}, where D_{f2}^{B}<D_{f2}^{A}. In other words, at some frequencies, the first delay generated by the bone conduction sound component 110 is greater than the second delay generated by the air conduction sound component 120, while at other frequencies, the first delay generated by the bone conduction sound component 110 is less than the second delay generated by the air conduction sound component 120.

Based on the above analysis, in some exemplary embodiments, the signal processing circuit 130 can determine which drive signal to delay and the corresponding delay duration in the following manner:
(1) Determine the delay difference information corresponding to the target frequency F0, where the delay difference information represents the difference between the first delay generated by the bone conduction sound component 110 at the target frequency F0 and the second delay generated by the air conduction sound component 120 at the target frequency F0.

Based on the foregoing analysis, it can be understood that at different frequencies, the difference between the first delay generated by the bone conduction sound component 110 and the second delay generated by the air conduction sound component 120 may exhibit different behaviors. For example, at frequency f1, the first delay generated by the bone conduction sound component 110 may be greater than the second delay generated by the air conduction sound component 120, while at frequency f2, the first delay generated by the bone conduction sound component 110 may be less than the second delay generated by the air conduction sound component 120. Therefore, before the acoustic device 200 leaves the factory, the bone conduction sound component 110 and the air conduction sound component 120 can be tested at multiple candidate frequencies to obtain the delay difference information corresponding to each candidate frequency. Here, candidate frequencies refer to frequencies that may serve as the intersection point between the bone conduction sound wave and the air conduction sound wave. For example, the multiple candidate frequencies may include 2000 Hz and 500 Hz.

The testing method for each candidate frequency is as follows: Generate a single-frequency test signal corresponding to the candidate frequency; Send the single-frequency test signal to the bone conduction sound component 110 to obtain the first test delay generated when the bone conduction sound component 110 converts the single-frequency test signal into a bone conduction test sound wave; Send the single-frequency test signal to the air conduction sound component 120 to obtain the second test delay generated when the air conduction sound component 120 converts the single-frequency test signal into an air conduction test sound wave; Based on the first test delay and the second test delay, generate the delay difference information corresponding to the candidate frequency.

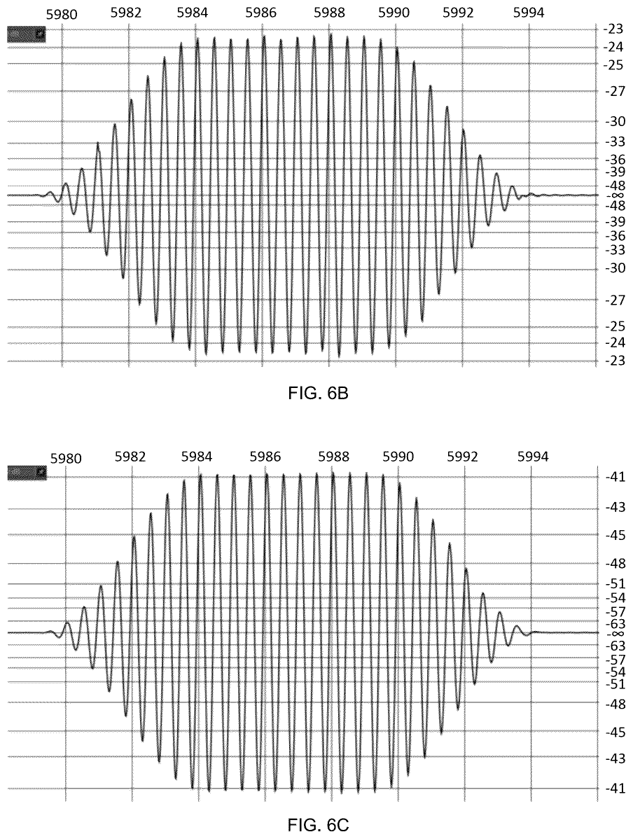

To facilitate understanding, the testing process for delay difference information is described below with reference to FIG. 6A to 6C, using the candidate frequency of 2000 Hz as an example.

First, generate a 2000 Hz single-frequency test signal with k cycles. The value of k is not limited, but it must ensure that the single-frequency test signal with k cycles contains a certain number of amplitude-stable signal cycles. For example, the value of k can be 30, in which case the 30-cycle single-frequency signal typically includes 12 cycles of amplitude-stable signals. FIG. 6A shows a schematic diagram of the single audio test signal with 30 cycles.

The aforementioned 30-cycle single-frequency test signal is sent to the bone conduction sound component 110 and the air conduction sound component 120, respectively. The bone conduction sound component 110 converts the 30-cycle single-frequency test signal into a 30-cycle bone conduction test sound wave, and the air conduction sound component 120 converts the 30-cycle single-frequency test signal into a 30-cycle air conduction test sound wave. During the above testing process, Audition software is used to record the operation of the bone conduction sound component 110, thereby obtaining the 30-cycle bone conduction test sound wave generated by the bone conduction sound component 110 and the generation time corresponding to each cycle of the bone conduction test sound wave. Similarly, during the above testing process, Audition software is used to record the operation of the air conduction sound component 120, thereby obtaining the 30-cycle air conduction test sound wave generated by the air conduction sound component 120 and the generation time corresponding to each cycle of the air conduction test sound wave. FIG. 6B shows the recording results of the 30-cycle bone conduction test sound wave generated by the bone conduction sound component 110, from which the generation time corresponding to each cycle of the bone conduction test sound wave can be obtained. FIG. 6C shows the recording results of the 30-cycle air conduction test sound wave generated by the air conduction sound component 120, from which the generation time corresponding to each cycle of the air conduction test sound wave can be obtained.

After obtaining the recordings shown in FIGS. 6B and 6C, the delay difference information can be determined by comparing the generation times of the bone conduction test sound wave and the air conduction test sound wave for the same cycle. To improve the accuracy of the delay difference information, cycles with stable amplitude can be selected for comparison. For example, one or more cycles from the 9th to the 20th cycle can be chosen for comparison. Using the 9th cycle as an example, by comparing FIGS. 6B and 6C, it can be determined that the delay difference information for the candidate frequency of 2000 Hz is as follows: the first delay generated by the bone conduction sound component 110 at the 2000 Hz frequency is 0.85 milliseconds greater than the second delay generated by the air conduction sound component 120 at the 2000 Hz frequency.

A person skilled in the art can understand that the above example uses the candidate frequency of 2000 Hz to illustrate the testing process for delay difference information. Similar testing methods can be applied to other candidate frequencies, and the present disclosure will not provide examples for each one.

After obtaining the delay difference information corresponding to each candidate frequency through testing, the correspondence relationship can be pre-stored in the acoustic device 200. The correspondence relationship may include: multiple candidate frequencies and the delay difference information corresponding to each candidate frequency. For example, taking the two candidate frequencies of 2000 Hz and 500 Hz as an example, assume that the delay difference information for the candidate frequency of 2000 Hz is: the first delay generated by the bone conduction sound component 110 at the 2000 Hz frequency is 0.85 milliseconds greater than the second delay generated by the air conduction sound component 120 at the 2000 Hz frequency; the delay difference information for the candidate frequency of 500 Hz is: the first delay generated by the bone conduction sound component 110 at the 500 Hz frequency is 0.20 milliseconds less than the second delay generated by the air conduction sound component 120 at the 500 Hz frequency. Then, the correspondence relationship shown in Table 1 below can be stored in the acoustic device 200.

TABLE 1
Candidate frequencies and their corresponding test results

| Candidate | | |
|---|---|---|
| frequency | 500 Hz | 2000 Hz |
| Delay difference | The first time delay generated by the | The first time delay generated by the |
| information | bone conduction sound component 110 | bone conduction sound component |
| | at a frequency of 500 Hz is 0.20 | 110 at a frequency of 2000 Hz is 0.85 |
| | milliseconds smaller than the second | milliseconds greater than the second |
| | time delay generated by the air | time delay generated by the air |
| | conduction sound component 120 at a | conduction sound component 120 at a |
| | frequency of 500 Hz. | frequency of 2000 Hz. |

In this way, when the signal processing circuit 130 needs to determine the delay difference information corresponding to the target frequency F0, it can retrieve the pre-stored correspondence relationship and query the correspondence relationship based on the target frequency F0 to obtain the delay difference information corresponding to the target frequency F0. For example, if the target frequency F0 is 500 Hz, the signal processing circuit 130 queries Table 1 based on the target frequency of 500 Hz to obtain the delay difference information corresponding to the target frequency of 500 Hz. Similarly, if the target frequency F0 is 2000 Hz, the signal processing circuit 130 queries Table 1 based on the target frequency of 2000 Hz to obtain the delay difference information corresponding to the target frequency of 2000 Hz. The above method, by pre-measuring and storing the delay difference information corresponding to multiple candidate frequencies, enables, on the one hand, rapid acquisition of the delay difference information for the target frequency based on the pre-stored measurement results, and on the other hand, ensures the accuracy of the obtained delay difference information.
(2) Based on the delay difference information, determine whether to delay the transmission of the first driving signal relative to the second driving signal, or to delay the transmission of the second driving signal relative to the first driving signal.

In other words, the signal processing circuit 130 can determine which driving signal to delay based on the delay difference information. Specifically, if the delay difference information indicates that the first delay generated by the bone conduction sound component 110 at the target frequency F0 is greater than the second delay generated by the air conduction sound component 120, the signal processing circuit 130 determines to delay the transmission of the second driving signal relative to the first driving signal. If the delay difference information indicates that the first delay generated by the bone conduction sound component 110 at the target frequency F0 is less than the second delay generated by the air conduction sound component 120, the signal processing circuit 130 determines to delay the transmission of the first driving signal relative to the second driving signal.
(3) Based on the delay difference information, determine the delay duration corresponding to the delayed transmission.

Specifically, after determining which driving signal to delay, the signal processing circuit 130 can further determine how long to delay the transmission of that driving signal based on the delay difference information.

An example is provided in conjunction with Table 1.

If the target frequency F0 is 2000 Hz, based on Table 1, since the first delay generated by the bone conduction sound component 110 at the 2000 Hz frequency is 0.85 milliseconds greater than the second delay generated by the air conduction sound component 120 at the 2000 Hz frequency, the signal processing circuit 130 can determine to delay the transmission of the second driving signal relative to the first driving signal, and determine that the corresponding delay duration for the delayed transmission is 0.85 milliseconds.

If the target frequency F0 is 500 Hz, based on Table 1, since the first delay generated by the bone conduction sound component 110 at the 500 Hz frequency is 0.20 milliseconds less than the second delay generated by the air conduction sound component 120 at the 500 Hz frequency, the signal processing circuit 130 can determine to delay the transmission of the first driving signal relative to the second driving signal, and determine that the corresponding delay duration for the delayed transmission is 0.20 milliseconds.

In some exemplary embodiments, after obtaining the delay difference information corresponding to multiple candidate frequencies through pre-testing, the delay scheme for each candidate frequency can be determined based on the delay difference information (i.e., which driving signal to delay and the duration of the delay). For example, for the candidate frequency of 2000 Hz, it can be determined that the second driving signal needs to be delayed relative to the first driving signal, with a corresponding delay duration of 0.85 milliseconds. For the candidate frequency of 500 Hz, it can be determined that the first driving signal needs to be delayed relative to the second driving signal, with a corresponding delay duration of 0.2 milliseconds. Thus, the delay schemes corresponding to each of the multiple candidate frequencies are obtained, as shown in Table 2.

TABLE 2
Candidate frequencies and their corresponding delay schemes

| Candidate frequency | 500 Hz | 2000 Hz |
|---|---|---|
| The delay of the second driving signal | 0 ms | 0.85 ms |
| (air conduction sound component) | | |
| The delay of the first driving signal | 0.2 ms | 0 |
| (bone conduction sound component) | | |

Furthermore, the delay schemes shown in Table 2 can be pre-stored in the acoustic device 200. In this way, the signal processing circuit 130 can query Table 2 based on the target frequency F0 to obtain the delay scheme corresponding to the target frequency F0, thereby determining which driving signal to delay and the duration of the delay. For example, if the target frequency F0 is 2000 Hz, by querying Table 2, it can be determined that the second driving signal should be delayed, with a corresponding delay duration of 0.85 milliseconds. Similarly, if the target frequency is 500 Hz, by querying Table 2, it can be determined that the first driving signal should be delayed, with a corresponding delay duration of 0.2 milliseconds.

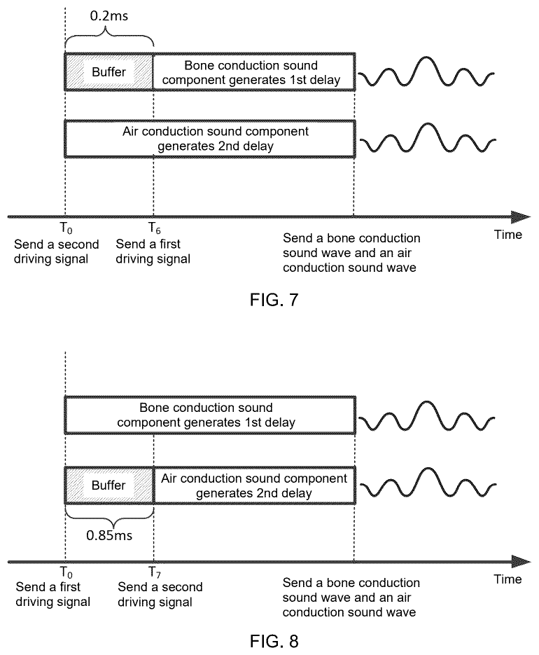

The following provides an example, with reference to FIGS. 7 and 8, of how the signal processing circuit 130 implements delayed transmission.

FIG. 7 illustrates a schematic diagram of delaying the transmission of the first driving signal. Referring to FIG. 7, assuming the target frequency is 500 Hz, the signal processing circuit 130, using the method described above, can determine that the first driving signal needs to be delayed by 0.2 milliseconds relative to the second driving signal. In this case, the signal processing circuit 130 can send the second driving signal to the air conduction sound component 120 at time T₀, while simultaneously buffering the first driving signal, and then send the first driving signal to the bone conduction sound component 110 after buffering for the delay duration (0.2 ms). For example, as shown in FIG. 7, the signal processing circuit sends the first driving signal to the bone conduction sound component 110 at time T₆, where T₆−T₀=0.2 ms. In this way, at 500 Hz, the generation time of the bone conduction sound wave by the bone conduction sound component 110 is the same as the generation time of the air conduction sound wave by the air conduction sound component 120, or the time difference between the two is minimal (less than or equal to 1 ms).

As shown in FIG. 7, the signal processing circuit 130 achieves a 0.2-millisecond delay of the first driving signal relative to the second driving signal by buffering the first driving signal for 0.2 milliseconds before transmission. This ensures that, at the target frequency of 500 Hz, the generation time of the bone conduction sound wave aligns with the generation time of the air conduction sound wave, or the time difference between the two is minimal (less than or equal to 1 ms). This can prevent the issue of sound deviation.

FIG. 8 illustrates a schematic diagram of delaying the transmission of the second driving signal. Referring to FIG. 8, assuming the target frequency is 2000 Hz, the signal processing circuit 130, using the method described above, can determine that the second driving signal needs to be delayed by 0.85 milliseconds relative to the first driving signal. In this case, the signal processing circuit 130 can send the first driving signal to the bone conduction sound component 110 at time T₀, while simultaneously buffering the second driving signal, and then send the second driving signal to the air conduction sound component 120 after buffering for the delay duration (0.85 ms). In other words, the signal processing circuit 130 sends the second driving signal to the air conduction sound component 120 at time T₇, where T₇−T₀=0.85 ms. In this way, at 2000 Hz, the generation time of the bone conduction sound wave by the bone conduction sound component 110 aligns with the generation time of the air conduction sound wave by the air conduction sound component 120, or the time difference between the two is minimal (less than or equal to 1 ms).

As shown in FIG. 8, the signal processing circuit 130 achieves a 0.85-millisecond delay of the second driving signal relative to the first driving signal by buffering the second driving signal for 0.85 milliseconds before transmission. This ensures that, at the target frequency of 2000 Hz, the generation time of the bone conduction sound wave aligns with the generation time of the air conduction sound wave, or the time difference between the two is minimal (less than or equal to 1 ms). This can prevent the issue of sound deviation.

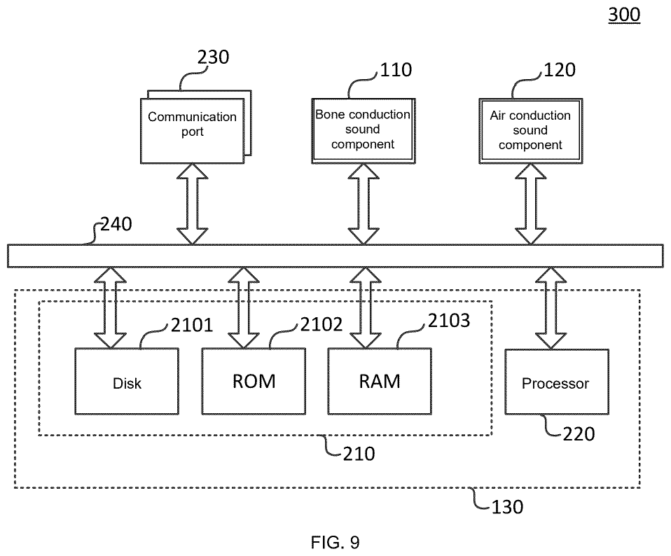

FIG. 9 illustrates a schematic diagram of the system architecture of another acoustic device 300 provided according to some exemplary embodiments of the present disclosure. As shown in FIG. 9, the acoustic device 300 may include a bone conduction sound component 110, an air conduction sound component 120, and a signal processing circuit 130. The signal processing circuit 130 may include: at least one storage medium 210 and at least one processor 220. It should be noted that, for the purpose of illustration only, the signal processing circuit 130 in the present disclosure includes at least one storage medium 210 and at least one processor 220. A person skilled in the art can understand that the signal processing circuit 130 may also include other hardware circuit structures, which are not limited in the present disclosure, as long as they can fulfill the functions mentioned in the present disclosure without departing from the spirit of the present disclosure.

Continuing to refer to FIG. 9, in some exemplary embodiments, acoustic device 300 may also include a communication port 230. The communication port 230 is used for data communication between the acoustic device and the external environment, for example, the communication port 230 may be used for data communication between the acoustic system and other devices/systems. In some exemplary embodiments, the acoustic device 300 may also include an internal communication bus 240. The internal communication bus 240 may connect different system components. For example, the bone conduction sound component 110, the air conduction sound component 120, a processor 220, a storage medium 210 and a communication port 230 may all be connected through the internal communication bus 240.

The storage medium 210 may include data storage device. The data storage device may be a non-transitory storage medium, or may be a transitory storage medium. For example, the data storage device may include one or more of magnetic disk 2101, read-only memory (ROM) 2102 or random access memory (RAM) 2103. Storage medium 210 also includes at least one instruction set stored in the data storage device. The instruction set includes instructions, the instructions are computer program code, the computer program code may include programs, routines, objects, components, data structures, processes, modules, etc. for executing the signal processing method provided by the present application. The signal processing method will be introduced later.

At least one processor 220 is used to execute the above at least one instruction set. When the acoustic system 003 is running, the at least one processor 220 reads the at least one instruction set, and according to the instructions of the at least one instruction set, executes the signal processing method provided by the present application. The processor 220 may execute all steps or partial steps included in the above signal processing method. The processor 220 may be in the form of one or more processors, in some exemplary embodiments, the processor 220 may include one or more hardware processors, such as microcontroller, microprocessor, reduced instruction set computer (RISC), application specific integrated circuit (ASIC), application-specific instruction set processor (ASIP), central processing unit (CPU), graphics processing unit (GPU), physics processing unit (PPU), microcontroller unit, digital signal processor (DSP), field programmable gate array (FPGA), advanced RISC machine (ARM), programmable logic device (PLD), any circuit or processor capable of executing one or more functions, etc., or any combination thereof. Merely for illustrative purposes, acoustic device 300 shown in FIG. 9 exemplifies the case of including only one processor 220. However, it should be noted that the acoustic device 300 provided by the present application may also include multiple processors, therefore, the operations and/or method steps disclosed in the present application may be executed by one processor, or may be executed jointly by multiple processors. For example, if in the present application processor 220 of the acoustic device 300 executes step A and step B, then it should be understood that step A and step B may also be executed jointly or separately by two different processors 220 (for example, the first processor executes step A, the second processor executes step B, or the first and second processors jointly execute steps A and B).

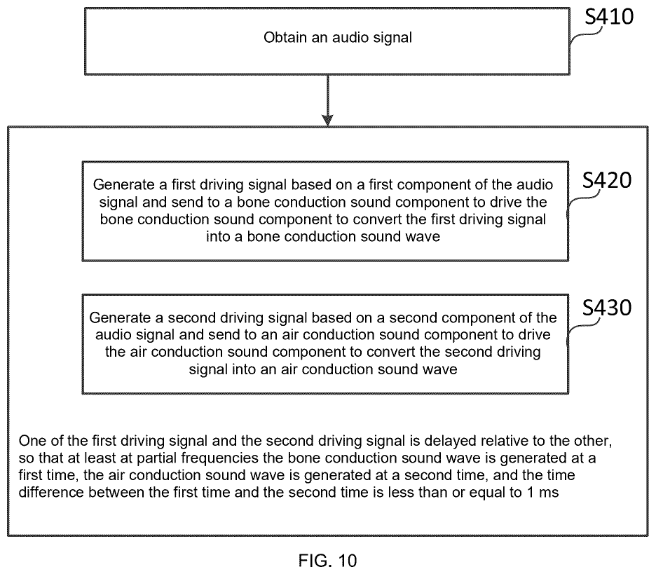

FIG. 10 shows a flow schematic diagram of a signal processing method P400 provided according to embodiments of the present disclosure. Signal processing circuit 130 may be configured to execute signal processing method P400. Specifically, the processor 220 in the signal processing circuit 130 reads at least one instruction set stored in the memory 210, and executes the signal processing method P400 according to the instructions of the at least one instruction set.

As shown in FIG. 10, the signal processing method P400 may include:

S410: Obtain an audio signal.

S420: Generate a first driving signal based on a first component of the audio signal and send to a bone conduction sound component to drive the bone conduction sound component to convert the first driving signal into a bone conduction sound wave.

S430: Generate a second driving signal based on a second component of the audio signal and send to an air conduction sound component to drive the air conduction sound component to convert the second driving signal into an air conduction sound wave.

One of the first driving signal and the second driving signal is delayed relative to the other, so that at least at partial frequencies the bone conduction sound wave is generated at a first time, the air conduction sound wave is generated at a second time, and the time difference between the first time and the second time is less than or equal to 100 microseconds.

In some exemplary embodiments, the at least partial frequencies include target frequency, the target frequency is a frequency corresponding to an intersection point of frequency response curves of the bone conduction sound wave and the air conduction sound wave.

In some exemplary embodiments, the first time delay varies with frequency changes of the bone conduction sound wave, the second time delay varies with frequency changes of the air conduction sound wave; and the method further includes: determining time delay difference information corresponding to the target frequency, the time delay difference information characterizes a difference between the first time delay generated by the bone conduction sound component at the target frequency and the second time delay generated by the air conduction sound component at the target frequency, based on the time delay difference information, determining to delay sending the first driving signal relative to the second driving signal, or determining to delay sending the second driving signal relative to the first driving signal, and based on the time delay difference information, determining a delay duration corresponding to the delayed sending.

In some exemplary embodiments, the delaying sending of the first driving signal relative to the second driving signal includes: sending the second driving signal to the air conduction sound component; and buffering the first driving signal while sending the second driving signal, and sending the first driving signal to the bone conduction sound component after buffering for the delay duration.

In some exemplary embodiments, the delaying sending of the second driving signal relative to the first driving signal includes: sending the first driving signal to the bone conduction sound component; and buffering the second driving signal while sending the first driving signal, and sending the second driving signal to the air conduction sound component after buffering for the delay duration.

In some exemplary embodiments, the determining the delay difference information corresponding to the target frequency includes: obtaining a pre-stored correspondence relationship, the correspondence relationship including multiple candidate frequencies and delay difference information corresponding to each candidate frequency; and querying the correspondence relationship based on the target frequency to obtain the delay difference information corresponding to the target frequency.

In some exemplary embodiments, the delay difference information corresponding to each candidate frequency is obtained through testing in the following manner: generating a single-frequency tone test signal corresponding to the candidate frequency; sending the single-frequency tone test signal to the bone conduction sound component to obtain a first test delay generated when the bone conduction sound component converts the single-frequency tone test signal into bone conduction test sound waves; sending the single-frequency tone test signal to the air conduction sound component to obtain a second test delay generated when the air conduction sound component converts the single-frequency tone test signal into air conduction test sound waves; and generating the delay difference information corresponding to the candidate frequency based on the first test delay and the second test delay.

In some exemplary embodiments, the first component corresponds to a mid-high frequency component in the audio signal; and the second component corresponds to a mid-low frequency component in the audio signal.

In some exemplary embodiments, the generating the first driving signal based on the first component of the audio signal includes: filtering the audio signal through a first filter to obtain the first component, the first filter being configured to allow the mid-high frequency component in the audio signal to pass through, and generating the first driving signal based on the first component; and the generating the first driving signal based on the first component of the audio signal includes: filtering the audio signal through a second filter to obtain the second component, the second filter being configured to allow the mid-low frequency component in the audio signal to pass through, and generating the second driving signal based on the second component.

It should be noted that the specific implementation methods and technical effects of the signal processing method P400 provided in the present disclosure can refer to the relevant descriptions above, and will not be repeated herein.

Another aspect of the present disclosure provides a non-transitory storage medium storing at least one set of executable instructions for signal processing. When the executable instructions are executed by a processor, the executable instructions direct the processor to implement the steps of the signal processing method P400 described in the present disclosure. In some possible implementations, various aspects of the present disclosure can also be implemented in the form of a program product, which includes program code. When the program product runs on an acoustic device, the program code is used to cause the acoustic device to execute the steps of the signal processing method P400 described in the present disclosure. The program product for implementing the above method can adopt a portable compact disc read-only memory (CD-ROM) including program code, and can run on an acoustic device. However, the program product of the present disclosure is not limited thereto. In the present disclosure, the readable storage medium can be any tangible medium that contains or stores a program, which can be used by or in combination with an instruction execution system. The program product can adopt any combination of one or more readable media. The readable medium can be a readable signal medium or a readable storage medium. The readable storage medium can be, for example, but is not limited to, an electrical, magnetic, optical, electromagnetic, infrared, or semiconductor system, apparatus, or device, or any combination of the above. More specific examples of readable storage media include: electrical connections with one or more wires, portable disks, hard disks, random access memory (RAM), read-only memory (ROM), erasable programmable read-only memory (EPROM or flash memory), optical fiber, portable compact disc read-only memory (CD-ROM), optical storage devices, magnetic storage devices, or any suitable combination of the above. The computer-readable storage medium can include data signals propagated in baseband or as part of a carrier wave, carrying readable program code. Such propagated data signals can take various forms, including but not limited to electromagnetic signals, optical signals, or any suitable combination of the above. The readable storage medium can also be any readable medium other than a readable storage medium, which can send, propagate, or transmit programs for use by or in combination with instruction execution systems, apparatus, or devices. Program code contained on readable storage media can be transmitted using any appropriate medium, including but not limited to wireless, wired, optical cable, RF, etc., or any suitable combination of the above. Program code for performing the operations of the present disclosure can be written in any combination of one or more programming languages, including object-oriented programming languages such as Java, C++, etc., as well as conventional procedural programming languages such as “C” language or similar programming languages. The program code can execute entirely on the acoustic device, partially on the acoustic device, as a standalone software package, partially on the acoustic device and partially on a remote computing device, or entirely on the remote computing device.

The above describes specific embodiments of the present disclosure. Other embodiments are within the scope of the appended claims. In some cases, the actions or steps recited in the claims can be performed in a different order than in the embodiments and still achieve the desired results. Additionally, the processes depicted in the drawings do not necessarily require the specific order shown or sequential order to achieve the desired results. In certain implementations, multitasking and parallel processing are also possible or potentially advantageous.

In summary, after reading this detailed disclosure, a person skilled in the art can understand that the foregoing detailed disclosure may be presented only by way of example and may not be limiting. Although not explicitly stated herein, a person skilled in the art can understand that the present disclosure is intended to encompass various reasonable changes, improvements and modifications to the embodiments. These changes, improvements and modifications are intended to be suggested by the present disclosure and are within the spirit and scope of the exemplary embodiments of the present disclosure.

Furthermore, certain terms in the present disclosure have been used to describe embodiments of the present disclosure. For example, “one embodiment,” “an embodiment,” and/or “some exemplary embodiments” means that particular features, structures, or characteristics described in connection with the embodiment may be included in at least one embodiment of the present disclosure. Therefore, it should be emphasized and understood that two or more references to “an embodiment” or “one embodiment” or “alternative embodiments” in various parts of the present disclosure do not necessarily all refer to the same embodiment. Furthermore, particular features, structures, or characteristics may be appropriately combined in one or more embodiments of the present disclosure.

It should be understood that in the foregoing description of embodiments of the present disclosure, in order to help understand one feature and for the purpose of simplifying the present disclosure, the present disclosure combines various features in a single embodiment, drawing, or description thereof. However, this does not mean that the combination of these features is necessary, and a person skilled in the art may mark out some of the devices as separate embodiments for understanding when reading the present disclosure. That is to say, the embodiments in the present disclosure can also be understood as an integration of multiple sub-embodiments. And the content of each sub-embodiment is also valid when it has fewer than all the features of a single aforementioned disclosed embodiment.

Each patent, patent application, publication of a patent application, and other materials, such as articles, books, specifications, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrations of the principles of the embodiments of the present disclosure. Other modified embodiments are also within the scope of the present disclosure. Therefore, the embodiments disclosed in the present disclosure are merely examples and not limitations. A person skilled in the art can adopt alternative configurations based on the embodiments in the present disclosure to implement the application in the present disclosure. Therefore, the embodiments of the present disclosure are not limited to the embodiments that have been precisely described in the application.

What is claimed is:

1. An acoustic device, comprising:
a bone conduction sound component, configured to generate a first time delay when converting a first driving signal into a bone conduction sound wave;
an air conduction sound component, configured to generate a second time delay when converting a second driving signal into an air conduction sound wave, wherein an absolute value of a difference between the second time delay and the first time delay is greater than 100 microseconds; and
a signal processing circuit, in communication with the bone conduction sound component and the air conduction sound component, when operating:
obtain an audio signal,
generates the first driving signal based on a first component of the audio signal and sends to the bone conduction sound component to drive the bone conduction sound component to convert the first driving signal into the bone conduction sound wave, and
generates the second driving signal based on a second component of the audio signal and sends to the air conduction sound component to drive the air conduction sound component to convert the second driving signal into the air conduction sound wave, wherein
one of the first driving signal and the second driving signal is delayed relative to the other, so that at least at partial frequencies the bone conduction sound wave is generated at a first time, the air conduction sound wave is generated at a second time, and a time difference between the first time and the second time is less than or equal to 100 microseconds.

2. The acoustic device according to claim 1, wherein the at least partial frequencies comprise a target frequency, the target frequency is a frequency corresponding to an intersection point of frequency response curves of the bone conduction sound wave and the air conduction sound wave.

3. The acoustic device according to claim 2, wherein the first delay varies with a frequency variation of the bone conduction sound wave, and the second delay varies with a frequency variation of the air conduction sound wave;
and
the signal processing circuit is further configured to:
determine delay difference information corresponding to the target frequency, wherein the delay difference information characterizes a difference between the first delay generated by the bone conduction sound component at the target frequency and the second delay generated by the air conduction sound component at the target frequency,
based on the delay difference information, determine to delay sending the first driving signal relative to the second driving signal, or determine to delay sending the second driving signal relative to the first driving signal, and
based on the delay difference information, determine a delay duration corresponding to the delayed sending.

4. The acoustic device according to claim 3, wherein to implement the delayed sending of the first driving signal relative to the second driving signal, the signal processing circuit is configured to:
send the second driving signal to the air conduction sound component; and
buffer the first driving signal while sending the second driving signal, and send the first driving signal to the bone conduction sound component after buffering for the delay duration.

5. The acoustic device according to claim 3, wherein to implement the delayed sending of the second driving signal relative to the first driving signal, the signal processing circuit is configured to:
send the first driving signal to the bone conduction sound component; and
buffer the second driving signal while sending the first driving signal, and send the second driving signal to the air conduction sound component after buffering for the delay duration.

6. The acoustic device according to claim 3, wherein to determine the delay difference information corresponding to the target frequency, the signal processing circuit is configured to:
obtain a pre-stored correspondence relationship, wherein the correspondence relationship comprises at least one candidate frequency and delay difference information corresponding to each candidate frequency; and
query the correspondence relationship based on the target frequency to obtain the delay difference information corresponding to the target frequency.

7. The acoustic device according to claim 6, wherein the delay difference information corresponding to each candidate frequency is obtained through testing in the following manner:
generating a single-frequency tone test signal corresponding to the candidate frequency;
sending the single-frequency tone test signal to the bone conduction sound component to obtain a first test delay generated when the bone conduction sound component converts the single-frequency tone test signal into a bone conduction test sound wave;
sending the single-frequency tone test signal to the air conduction sound component to obtain a second test delay generated when the air conduction sound component converts the single-frequency tone test signal into an air conduction test sound wave; and
generating delay difference information corresponding to the candidate frequency based on the first test delay and the second test delay.

8. The acoustic device according to claim 2, wherein the target frequency is 2000 Hz or 500 Hz.

9. The acoustic device according to claim 1, wherein the at least partial frequencies comprise frequencies in a frequency interval [freq, 2*freq], wherein the freq is a frequency corresponding to an intersection point of voltage curves of the first driving signal and the second driving signal.

10. The acoustic device according to claim 1, wherein the first component corresponds to a mid-high frequency component in the audio signal; and
the second component corresponds to a mid-low frequency component in the audio signal.

11. The acoustic device according to claim 10, wherein
to generate the first driving signal, the signal processing circuit is configured to:
filter the audio signal with a first filter to obtain the first component, wherein the first filter is configured to allow the mid-high frequency component in the audio signal to pass through, and
generate the first driving signal based on the first component; and
to generate the second driving signal, the signal processing circuit is configured to:
filter the audio signal with a second filter to obtain the second component, wherein the second filter is configured to allow the mid-low frequency component in the audio signal to pass through, and
generate the second driving signal based on the second component.

12. The acoustic device according to claim 1, wherein
the air conduction sound component at least comprises:
an air conduction speaker, and
a digital power amplifier, connected to an input end of the air conduction speaker; and
the bone conduction sound component at least comprises:
a bone conduction speaker, and
an analog power amplifier, connected to an input end of the bone conduction speaker.

13. A signal processing method, wherein the method is applied to an acoustic device comprising a bone conduction sound component, an air conduction sound component and a signal processing circuit, the bone conduction sound component is configured to generate a first time delay when converting a first driving signal into a bone conduction sound wave, the air conduction sound component is configured to generate a second time delay when converting a second driving signal into an air conduction sound wave, and an absolute value of a difference between the second time delay and the first time delay is greater than 100 microseconds, the method comprises: by the processing circuit,
obtain an audio signal;
generates the first driving signal based on a first component of the audio signal and sends to the bone conduction sound component to drive the bone conduction sound component to convert the first driving signal into the bone conduction sound wave; and
generates the second driving signal based on a second component of the audio signal and sends to the air conduction sound component to drive the air conduction sound component to convert the second driving signal into the air conduction sound wave, wherein
one of the first driving signal and the second driving signal is delayed relative to the other, so that at least at partial frequencies the bone conduction sound wave is generated at a first time, the air conduction sound wave is generated at a second time, and a time difference between the first time and the second time is less than or equal to 100 microseconds.

14. The method according to claim 13, wherein the at least partial frequencies comprise a target frequency, the target frequency is a frequency corresponding to an intersection point of frequency response curves of the bone conduction sound wave and the air conduction sound wave.

15. The method according to claim 14, wherein the first delay varies with a frequency variation of the bone conduction sound wave, and the second delay varies with a frequency variation of the air conduction sound wave;
and
the method further comprises, by the signal processing circuit:
determining delay difference information corresponding to the target frequency, wherein the delay difference information characterizes a difference between the first delay generated by the bone conduction sound component at the target frequency and the second delay generated by the air conduction sound component at the target frequency,
based on the delay difference information, determining to delay sending the first driving signal relative to the second driving signal, or determining to delay sending the second driving signal relative to the first driving signal, and
based on the delay difference information, determining a delay duration corresponding to the delayed sending.

16. The method according to claim 15, wherein the determining to delay sending the first driving signal relative to the second driving signal comprises:
sending the second driving signal to the air conduction sound component; and
buffering the first driving signal while sending the second driving signal, and sending the first driving signal to the bone conduction sound component after buffering for the delay duration.

17. The method according to claim 15, wherein the determining to delay sending the second driving signal relative to the first driving signal comprises:
sending the first driving signal to the bone conduction sound component; and
buffering the second driving signal while sending the first driving signal, and sending the second driving signal to the air conduction sound component after buffering for the delay duration.

18. The method according to claim 15, wherein the determining of the delay duration corresponding to the delayed sending based on the delay difference information comprises:
obtaining a pre-stored correspondence relationship, wherein the correspondence relationship comprises at least one candidate frequency and delay difference information corresponding to each candidate frequency; and
querying the correspondence relationship based on the target frequency to obtain the delay difference information corresponding to the target frequency.

19. The method according to claim 13, wherein the at least partial frequencies comprise frequencies in a frequency interval [freq, 2*freq], wherein the freq is a frequency corresponding to an intersection point of voltage curves of the first driving signal and the second driving signal.

20. The method according to claim 13, wherein the first component corresponds to a mid-high frequency component in the audio signal; and
the second component corresponds to a mid-low frequency component in the audio signal.
